(19) United States
(12) Patent Application Publication
(10) Pub. No.: US 2024/0192951 A1
(43) Pub. Date: Jun. 13, 2024

(54) System Maintenance Status Controller

(71) Applicant: SAP SE, Walldorf (DE)

(72) Inventors: Wulf Kruempelmann, Altlussheim (DE); Susanne Schott, Walldorf (DE)

(21) Appl. No.: 18/078,339

(22) Filed: Dec. 9, 2022

(51) Int. Cl. G06F 8/71

(52) U.S. Cl. CPC G06F 8/71

(57) ABSTRACT

A method, a system, and computer program product to manage simultaneous running of compatible processes on computing systems are described. A request to perform an execution of a service is received at a computing system. An activity status of the computing system identified to execute the service is determined. The activity status includes an identification of a process scheduled to be executed by the computing system. A compatibility report indicating a compatibility between the execution of the service at the computing system and the process is generated. The execution of the service at the computing system is selectively initiated based on the compatibility between the execution of the service at the computing system and the process.

### TECHNICAL FIELD

The disclosed subject matter generally relates to maintenance processes of computer systems and more particularly to automated handling of computing system states.

### BACKGROUND

In complex computer cloud scenarios, the status of a computer system can be changed by several different tools. Some of the tools that change the status of a computer system are controlled by a central system controlling tool, some processes are controlled by a user device, and some processes by external process engines. A portion of the maintenance processes within a computer system are not compatible with other processes, and the execution of some customer-triggered processes starts can be limited in a maintenance state. Some processes can be executed in maintenance state but can trigger one or more system issues, such as power supply issues, technical (hardware) problems, internal (e.g., memory limitation due to the number of simultaneously executed applications) problems, internal service problems, and/or run upgrade problems. The incompatibility between process execution and maintenance as well as the problems related to several processes disturbing each other on the same system can raise difficulties with manually performing maintenance processes.

### SUMMARY

For purposes of summarizing, certain aspects, advantages, and novel features have been described herein. It is to be understood that not all such advantages can be achieved in accordance with any one particular implementation. Thus, the disclosed subject matter can be embodied or carried out in a manner that achieves or optimizes one advantage or group of advantages without achieving all advantages as can be taught or suggested herein.

In accordance with some implementations of the disclosed subject matter, manufactured articles, devices, systems and methods are provided for automated control of system maintenance state. In one aspect, a computer-implemented method includes: receiving, by one or more processors, a request to perform an execution of a service at a computing system, determining, by the one or more processors, an activity status of the computing system identified to execute the service, the activity status including an identification of a process scheduled to be executed by the computing system, generating, by the one or more processors, a compatibility report indicating a compatibility between the execution of the service at the computing system and the process, selectively initiating, by the one or more processors, the execution of the service at the computing system based on the compatibility between the execution of the service at the computing system and the process.

In some variations, one or more features disclosed herein including the following features can optionally be included in any feasible combination. In some implementations, the service is called by an internal maintenance process or by a customer-controlled process. In some implementations, the compatibility report indicates a conflict between the execution of the service at the computing system and the process. In some implementations, the selectively initiating, by the one or more processors, the execution of the service at the computing system includes blocking the execution of the service at the computing system. In some implementations, the computer-implemented method can further include redirecting, by the one or more processors, the service to another system identified as being free of conflicts with the service. In some implementations, the activity status includes a duration and a resource allocation for the process scheduled to be executed by the computing system. In some implementations, the computer-implemented method can further include adding, by the one or more processors, the execution of the service to the activity status.

In another aspect, a non-transitory computer-readable storage medium includes programming code, which when executed by at least one data processor, causes operations including: receiving a request to perform an execution of a service at a computing system, determining an activity status of the computing system identified to execute the service, the activity status including an identification of a process scheduled to be executed by the computing system, generating a compatibility report indicating a compatibility between the execution of the service at the computing system and the process, and selectively initiating the execution of the service at the computing system based on the compatibility between the execution of the service at the computing system and the process.

In some variations, one or more features disclosed herein including the following features can optionally be included in any feasible combination. In some implementations, the service is called by an internal maintenance process or by a customer-controlled process. In some implementations, the compatibility report indicates a conflict between the execution of the service at the computing system and the process. In some implementations, the selectively initiating, by the one or more processors, the execution of the service at the computing system includes blocking the execution of the service at the computing system. In some implementations, the operations can further include redirecting, by the one or more processors, the service to another system identified as being free of conflicts with the service. In some implementations, the activity status includes a duration and a resource allocation for the process scheduled to be executed by the computing system. In some implementations, the operations can further include adding, by the one or more processors, the execution of the service to the activity status.

In another aspect, a system includes: at least one data processor, and at least one memory storing instructions, which when executed by the at least one data processor, cause operations including: receiving a request to perform an execution of a service at a computing system, determining an activity status of the computing system identified to execute the service, the activity status including an identification of a process scheduled to be executed by the computing system, generating a compatibility report indicating a compatibility between the execution of the service at the computing system and the process, and selectively initiating the execution of the service at the computing system based on the compatibility between the execution of the service at the computing system and the process.

In some variations, one or more features disclosed herein including the following features can optionally be included in any feasible combination. In some implementations, the service is called by an internal maintenance process or by a customer-controlled process. In some implementations, the compatibility report indicates a conflict between the execution of the service at the computing system and the process. In some implementations, the selectively initiating, by the one or more processors, the execution of the service at the computing system includes blocking the execution of the service at the computing system. In some implementations, the operations can further include redirecting, by the one or more processors, the service to another system identified as being free of conflicts with the service. In some implementations, the activity status includes a duration and a resource allocation for the process scheduled to be executed by the computing system. In some implementations, the operations can further include adding, by the one or more processors, the execution of the service to the activity status.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that can include one or more processors and one or more memories coupled to the one or more processors. A memory, which can include a non-transitory computer-readable or machine-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates an example operating environment, in accordance with some example implementations;

FIG. 2 depicts an example of an architecture, in accordance with some example implementations;

FIG. 3 depicts a flowchart illustrating an example process, in accordance with some example implementations; and

FIG. 4 depicts a block diagram illustrating a computing system, in accordance with some example implementations.

Where practical, the same or similar reference numbers denote the same or similar or equivalent structures, features, aspects, or elements, in accordance with one or more implementations.

### DETAILED DESCRIPTION

The disclosed subject matter relates to automated control of system maintenance state by using a database that can handle the states of a computing system. A central system can access the database to manage simultaneous running of compatible processes on computing systems and to ensure that maintenance processes can be executed by computer systems. The central system can access the database to identify computer systems scheduled for maintenance, undergoing maintenance, and available to execute external processes, as online services.

In particular, the central system described herein can process incoming requests to perform execution of services at a computing system. The central system can identify a computing system to execute a service and can access the database to determine an activity status of the computing system identified to execute the online service. The activity status can include an identification of a process scheduled to be executed by the computing system identified to execute the online service, such as a maintenance process and/or another process that can be compatible or incompatible (relative to processing requirements associated with) the execution of the online service. A compatibility report indicating a compatibility between the execution of the service at the computing system and the scheduled and/or ongoing process of the computing system identified to execute the online service can be generated. The execution of the service at the computing system can be selectively initiated based on the compatibility between the execution of the service at the computing system and the scheduled and/or ongoing process. The compatibility verification and the selective initiation of processes described herein can actively prevent computing system issues related to incompatible processes, such as power supply issues, technical (hardware) problems, internal (e.g., memory limitation due to the number of simultaneously executed applications) problems, internal service problems, and/or run upgrade problems. As another advantage, automatic scheduling of compatible processes, including computing system maintenance can avoid problems related to several processes disturbing each other on the same computing system that appear when performance of maintenance processes are manually initiated without considering other processes or when online services are initiated on a computing system scheduled for maintenance.

To overcome the above deficiencies computer-implemented systems and methods are provided, in accordance with one or more implementations, for storing process data in a database to assist with automatic verification and selective initiation of processes on computing systems. As another advantage of the proposed solution described herein, the central system can use a load balancer to redirect a request to perform an execution of a service to a computing system with a compatibility report indicating a compatibility between the execution of the service at the computing system and the process. As another advantage, the described process optimizes memory usage and an overall central processing unit (CPU) consumption for process execution to avoid reaching processing limits of the computing systems. Analyzing process execution duration of a particular process type in history data can avoid resource issues that can lead to incomplete process execution.

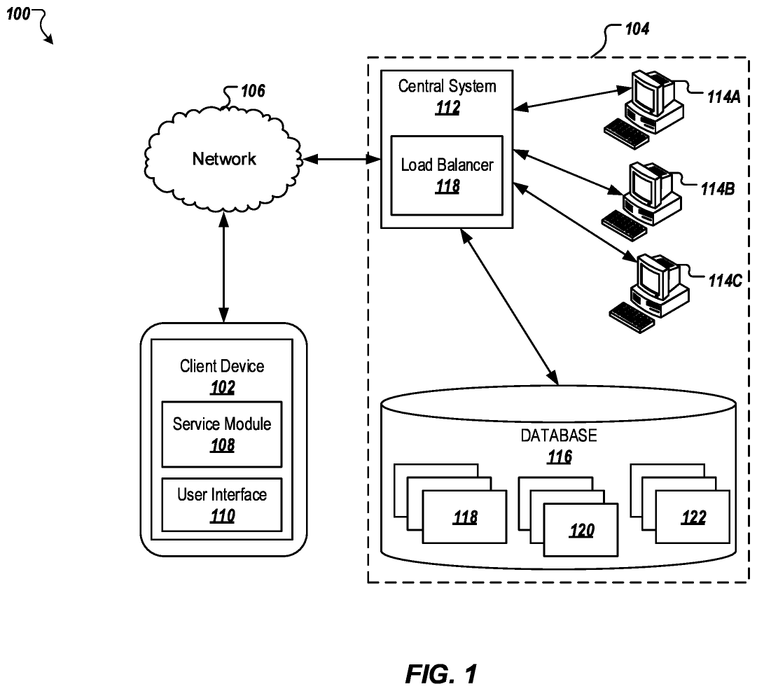

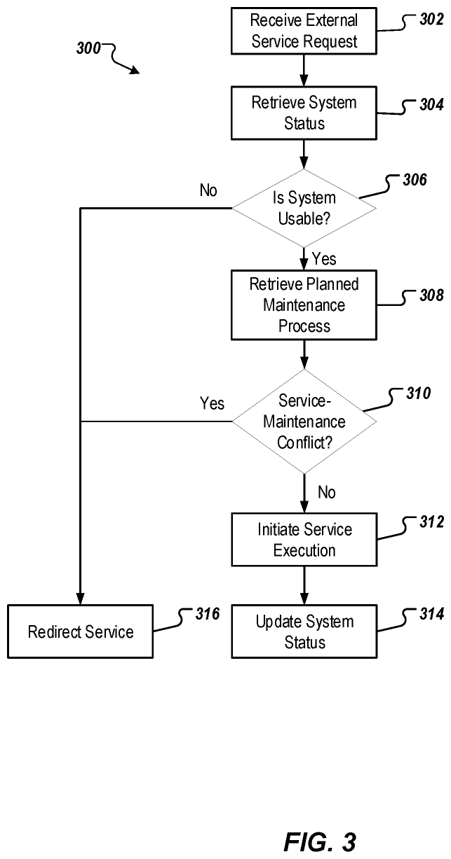

FIG. 1 illustrates an example of a system 100 for automated control of system maintenance state by using a database that can handle the states of a computing system, according to some implementations of the current subject matter. The system 100 can be configured to execute one or more processes for automatic verification and selective initiation of processes on computing systems, such as example process 300 described with reference to FIG. 3. The system 100 can include a client device 102, a server system 104, and a network 106.

The client device 102 can be associated with an entity authorized to use an online application hosted by the server system 104 that can be executed as a service. In the depicted example, the client device 102 includes a service module 108 and a user interface 110. The service module 108 can interact with an online application that is hosted by the server system 104, for example, during an authenticated session. The service module 108 can be configured to enable transmission, to the server system 104, of user authentication information and service requests during an authenticated session. The user interface 110 can enable entry of a user input including the user authentication information and selection of the service requests.

The client device 102 can be and/or include any type of processor and memory based device, such as, for example, cellular phones, smart phones, tablet computers, laptop computers, desktop computers, workstations, personal digital assistants (PDA), network appliances, cameras, enhanced general packet radio service (EGPRS) mobile phones, media players, navigation devices, email devices, game consoles, or an appropriate combination of any two or more of these devices or other data processing devices. Even though, not illustrated, in some implementations, multiple client devices 102 including different computing system configurations, such as different operating systems, different processing capabilities, different hardware components, and/or other differences can concurrently request services, during authenticated sessions, from the server system 104. As shown in FIG. 1, the client device 102 can be communicatively coupled with the server system 104 during an authenticated session, via the network 106. It should be appreciated that the network 106 can be any wired and/or wireless network including, for example, a public land mobile network (PLMN), a local area network (LAN), a wide area network (WAN), the Internet, a cellular network, a telephone network (e.g., PSTN) or an appropriate combination thereof connecting any number of communication devices, mobile computing devices, fixed computing devices, server systems, and/or the like. The client device 102 can include any combination of fixed and variable computing components.

The server system 104 can include a distributed data processing system. In some implementations, the server system 104 and/or any of its components can be incorporated and/or part of a container system that can be used in cloud implementations. The server system 104 can include any form of servers including, but not limited to a web server (e.g., cloud-based server), an application server, a proxy server, a network server, and/or a server pool. In general, the server system 104 can accept requests to execute services that enables process optimization. The server system 104 can include a central system 112, a plurality of computing systems 114A, 114B, 114C and a database 116. The central system 112 can be configured to securely manage multi-cloud workloads, by accessing data stored in the database 116 to identify which of the computing systems 114A, 114B, 114C can execute requested services without generating conflicts with ongoing or scheduled maintenance processes and/or services.

The central system 112 can include a computer system. The central system 112 can include a general purpose computer, a handheld mobile device, a tablet, or other communication capable device, sensor or monitor. The central system 112 can include one or more processors and a load balancer 118. The central system 112 can include a memory coupled to the one or more processors of the central system 112. The memory of the central system 112 can include a non-transitory computer-readable or machine-readable storage medium that can include, encode, store, or the like one or more programs that cause the one or more processors of the central system 112 to schedule execution of processes and services to be executed by the computing systems 114A, 114B, 114C, as described herein. For example, the central system 112 can schedule execution of maintenance processes and can selectively initiate execution of services at any of the computing systems 114A, 114B, 114C based on the compatibility between the execution of the service at the computing systems 114A, 114B, 114C and the scheduled or ongoing processes.

The central system 112 can adaptively direct, using a load balancer 118, the requested services to one of the available computing systems 114A, 114B, 114C running compatible processes, to reduce latency, improve the reliability, and efficiency of service execution without affecting (disrupting) maintenance processes. The central system 112 can use the load balancer 118 to adapt the capacity of the server system 104 for workload through a securely integrated relationship of multi cloud services and computing systems 114A, 114B, 114C. In some implementations, the load balancer 118 can load-balance incoming service requests according to a round-robin distributions scheme, regulated relative to ongoing and/or scheduled services to adaptively direct the requested services to the computing systems 114A, 114B, 114C, to which various service operations are directed in a sequential and continuous manner. In some cases, automatic migration is initiated by carrying out a series of matching, loading and invocation steps relative to scheduled processes indicated by data stored by the database 116.

In some implementations of the current subject matter, even if a computing system 114A in the server system 104 is identified as being unavailable (has insufficient processing resources) due to one or more factors (e.g., other internal processes, external processes, and/or maintenance processes), another computing system 114B can be identified, based on data stored by the database 116, by the central system 112, to serve a pending request, seamlessly for the client device 102. Using the described server system 104, the client device 102 does not experience any difference when the central system 112 redirects service requests from a first computing system 114A that completed a previous service to a second computing system 114B assigned by the central system 112 to complete a subsequent service, using related state data stored by the database 116.

The database 116 can be any type of database including, for example, an in-memory database, a relational database, a non-SQL (NoSQL) database, and/or the like. The database 116 can be a dedicated, single-container database system corresponding to a single instance of the computing systems 114A, 114B, 114C. In some implementations, the database 116 includes a multitenant database architecture (e.g., multitenant database containers (MDC)), such that each tenant of the database 116 can be served by separate instances of the computing systems 114A, 114B, 114C. In some implementations, the database 116 stores process data received based on a process data type as indicated by attributes or tags (e.g., data or metadata defining a type, quality, source, or attribute associated with the process data). The database 116 can transmit the collected process data and process history data, to the central system 112. The central system 112 can include hardware or software implementations (e.g., applications or software objects instantiated over one or more computing systems) that can process the data received from the database 116, to generate one or more triggering events, for one or more of the computing systems 114A, 114B, 114C. Depending on implementation, the collected process data can be clustered or categorized into different groups in association with different attributes (e.g., data source, priority, sensitivity, quality, quantity, urgency, context or other factors) that can identify particular processes as more important or interesting for the purpose of detecting a triggering event, for example. In some implementations, different categories and groups of process data can be collected, identified, stored or streamed as belonging to different process types.

For example, the database 116 can be configured to store computing system data 118, maintenance data 120, and external process data 122 related to each of the computing systems 114A, 114B, 114C. The computing system data 118 can include current processes being executed by the computing systems 114A, 114B, 114C and processing resources of the computing systems 114A, 114B, 114C indicative of the status of the computing systems 114A, 114B, 114C relative to the running processes. The maintenance data 120 can include maintenance planning information as well as planned run time for maintenance processes for each of the computing systems 114A, 114B, 114C. The external process data 122 can include information about ongoing and/or scheduled process information related to execution of services at the computing systems 114A, 114B, 114C and processing resources of the computing systems 114A, 114B, 114C indicative of the status of the computing systems 114A, 114B, 114C relative to the external processes. The external process data 122 can include history process data indicative of the processing resources used by the computing systems 114A, 114B, 114C during past execution of services at the computing systems 114A, 114B, 114C.

The computing systems 114A, 114B, 114C can be and/or include any type of processor and memory based device, such as a general purpose computer, a handheld mobile device, a tablet, or other communication capable device, sensor or monitor. The computing systems 114A, 114B, 114C can include a software or hardware implemented device configured to execute multiple processes (including services) and can undergo maintenance processes during particular times. The computing systems 114A, 114B, 114C can include a dedicated application or other type of software application, to execute services in response to service requests received from the client device 102. It is noteworthy that the computing systems 114A, 114B, 114C and other software or hardware elements of the central system 112 associated with optimizing execution of services according to a maintenance status, can be implemented over a centralized or distributed (e.g., cloud-based) computing environment as dedicated resources or can be configured as virtual machines that define shared processing or storage resources. In some implementations, processing resources the computing systems 114A, 114B, 114C can be efficiently allocated, prioritized or utilized to ensure compatibility between simultaneously executed processes and without disrupting maintenance processes. The proposed implementations discussed above and as illustrated in the accompanying figures overcome the deficiencies associated with the traditional systems that include manual initiation of maintenance processes and/or allocation of service execution to computing systems 114A, 114B, 114C independent of the ongoing or scheduled maintenance processes.

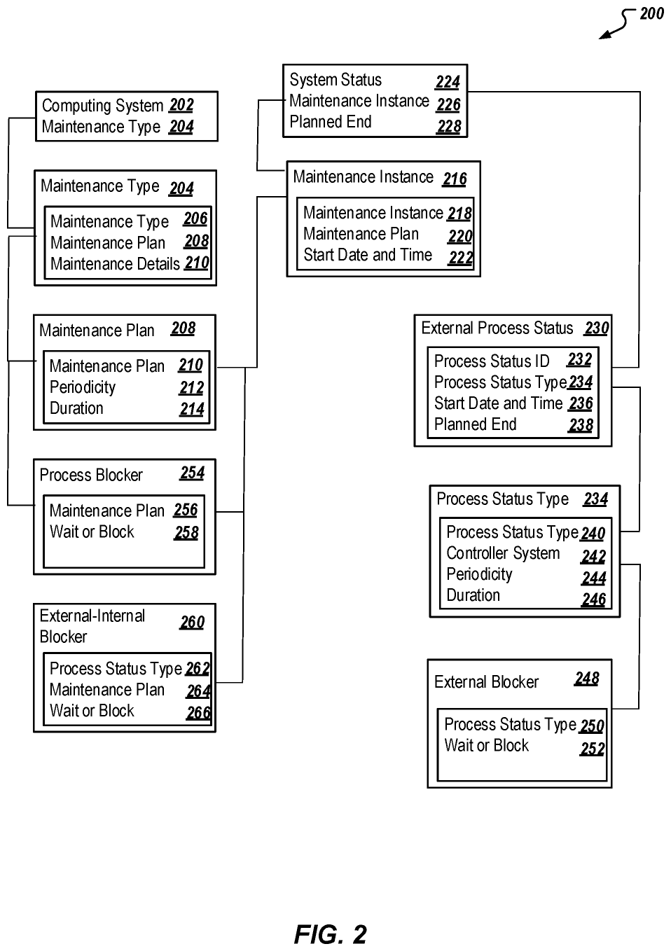

FIG. 2 illustrates an example of an architecture 200 for automated verification and selective initiation of processes on computing systems. The example of the architecture 200 can be implemented on any component or any combination of components of the example system 100 described with reference to FIG. 1. For example, the architecture 200 includes data types that can be saved by a database (e.g., database 116 described with reference to FIG. 1) and can be processed by a central system (e.g., central system 112 described with reference to FIG. 1) to identify a computing system (e.g., one of computing systems 114A, 114B, 114C described with reference to FIG. 1) to execute a service.

The central system can identify a computing system 202 as a potential target to execute a service. The identification of the computing system includes identifying the respective maintenance type 204. The maintenance type 204 associated with a computing system 202, as saved by the database, can include a maintenance process type 206, a maintenance plan 208, and maintenance details 210 (e.g., describing affected components of the computing system). The maintenance plan 208, as saved by the database, can include maintenance plan details 210 (e.g., describing components of the plan), a periodicity of the plan 212, and a duration of the plan 214. The maintenance plan details 210, as saved by the database, can include maintenance instance 216. The maintenance instance 216, as saved by the database, can include maintenance instance details 218 (e.g., describing components of the maintenance instance), a maintenance instance plan 220, and a start date and time of the maintenance instance 222. The maintenance instance 216 can be associated with a computing system status 224, a maintenance instance identifier 226, and a planned end 228 (e.g., an estimate of a day and time of completion of the respective maintenance process). The computing system status 224 can identify the computing system as being unavailable to execute other processes and/or services that are independent from the maintenance process.

If the computing system status 224 indicates that the computing system is not blocked or scheduled to be unavailable because of a maintenance process, an external process status is verified 230. The verification of the external process status can include retrieving from the database a process status identifier 232 for ongoing and/or scheduled processes for the respective computing system, a process status type 234, a process start date and time 236, and a process planned end 238. The process status type 234, as saved by the database, can include a process status type identifier 240, a controller system 242 (e.g., an identifier of a system controlling an execution of the process), a periodicity of the process 244 (e.g., indicating a schedule to execute the process), and a duration of the process 246 (e.g., historical data including past durations of the process). The process status type 234 can trigger an external blocker 248 that can be associated with a process status type 250 (indicative of one or more processes that can be incompatible with other processes or that can consume a large portion of the processing resources of the computing system) and a recommended action (wait or block action) 252 associated with the selective initiation (e.g., initiation, wait, or block) of the service execution.

If the computing system status 224 indicates that the computing system is blocked or scheduled to be unavailable because of a maintenance process, a process blocker 254 can be called. The process blocker 254 can include a maintenance plan 256 associated with the process block and a recommended action (wait or block action) 258. The process blocker 254 can trigger an external-internal blocker 260. The external-internal blocker 260 can include a process status type identifier 262, a maintenance plan 264, and a recommended action (wait or block action) 266. For example, if a computing system is scheduled to start a maintenance process within a particular time interval (e.g., within 2 hours) and a service to be executed is expected (based on past service execution data) to last a period of time that overlaps with the scheduled maintenance process (e.g., 3 to 4 hours), a compatibility report indicates that the service execution is blocked on the initially selected computing system and another computing system would need to be identified, using a data processing architecture 200, as described with reference to FIG. 2.

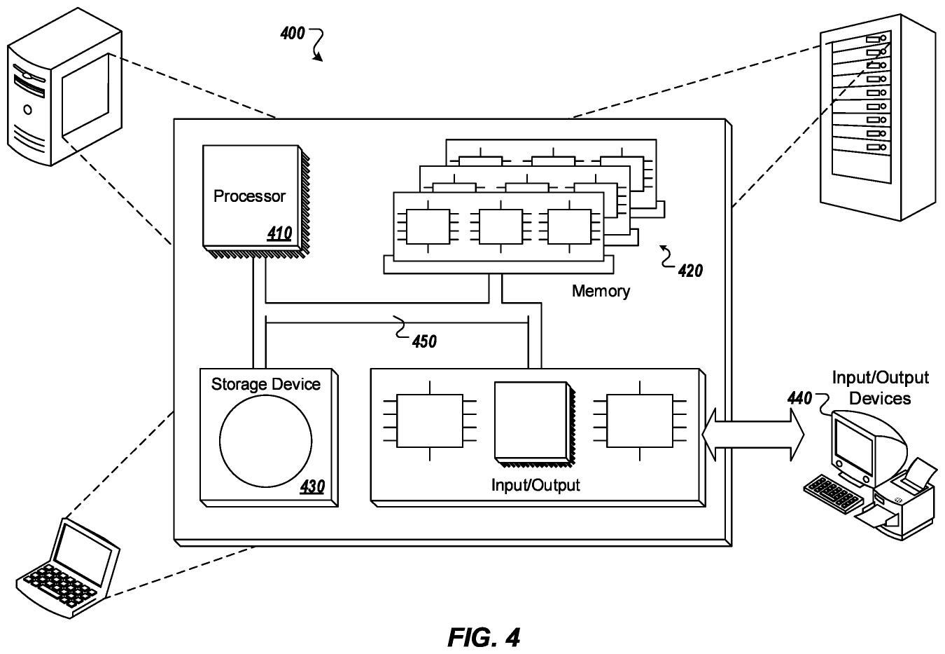

FIG. 3 depicts a flowchart illustrating a process 300 for automated control of system maintenance state by using a database, in accordance with some example implementations. The process 300 can be executed by the system 100 shown in FIG. 1, using the example data architecture 200 shown in FIG. 2, the system 400 shown in FIG. 4 or any combination thereof.

At 302, a request to perform an execution of a service at a computing system is received. The service can include execution of an online application using a computing system of a server. For example, the service can include processing of an item data set including multiple (e.g., thousands of) items (e.g., timesheets, log entries, or any type of multidimensional data, such as tables) that can be generated at a set frequency (e.g., on a daily basis) by an entity (e.g., customer or user) identifiable using an entity identifier. The number of items in the item data set can be proportional to a service execution duration, such that the number of items in the item data set can be used in combination with service history data to determine the service execution duration. The service history data can include information about past services, including past service durations, and size of item data set (e.g., number of items in the item data set). The service can correspond to a service type that defines a processing type corresponding to the type of item data. In some implementations, the service can be called by an internal maintenance process or by a customer-controlled process requested from a client device.

At 304, an activity status of an initial computing system identified to execute the service is retrieved from a database. The activity status can include an identification of an ongoing process or a process scheduled to be executed by the computing system, which affects the selective initiation (e.g., initiation, wait, or block) of the service execution. The identified process can be provided with a scheduled start time, estimated process duration, and an identifier of a process type that can indicate the processing resources of the computing system allocated to execute the process.

At 306, it is determined whether the initial computing system is usable for executing the service based on the activity status. The availability of the initial computing system to execute the service can be determined by comparing the timing of the potential service execution with the timing of the ongoing process and/or scheduled process. If the timing of the potential service execution overlaps with the timing of the ongoing process and/or scheduled process, a compatibility between the service execution and the ongoing process and/or scheduled process is determined based on the processing resources required to complete the service and the process. The processing resources can be estimated based on service history data and process history data retrieved from the database. If the sum of the processing resources required to complete the service and the process is below the processing resources of the initial computing system, the service execution is compatible with the ongoing process and/or scheduled process. If the sum of the processing resources required to complete the service and the process exceeds the processing resources of the initial computing system, the service execution is incompatible with the ongoing process and/or scheduled process and the service execution, at 316, can be redirected to a different computing system.

At 308, a planned maintenance process of the initial computing system identified to execute the service is retrieved from the database to determine the selective initiation (e.g., initiation, wait, or block) of the service execution. The planned maintenance process can include an identification of a maintenance process scheduled to be executed by the computing system. The identified planned maintenance process can be provided with a scheduled start time, estimated maintenance process duration, and an identifier of a maintenance process type that can indicate the processing resources of the computing system allocated to execute the process. The identified maintenance process can include a maintenance process that can be compatible with some service types or incompatible with any service type.

At 310, it is determined whether the initial computing system is usable for executing the service based on the planned maintenance process. The availability of the initial computing system to execute the service can be determined by comparing the timing of the potential service execution with the timing of the planned maintenance process. If the timing of the potential service execution overlaps with the timing of the planned maintenance process, a compatibility between the service execution and the planned maintenance process is determined based on the processing resources required to complete the service and the planned maintenance process, wherein the planned maintenance process is considered as having a top execution priority. The processing resources can be estimated based on service history data and planned maintenance process history data retrieved from the database. If the sum of the processing resources required to complete the service and the planned maintenance process is below the processing resources of the initial computing system and the planned maintenance process does not require a restart of the computing system that might disrupt the service execution, the service execution is determined to be compatible with the planned maintenance process. If the sum of the processing resources required to complete the service and the planned maintenance process exceeds the processing resources of the initial computing system or the planned maintenance process requires a restart of the computing system that might disrupt the service execution, the service execution is incompatible with the planned maintenance process.

At 312, if the service execution is determined to be compatible with an ongoing process, a scheduled process, and/or planned maintenance process, the service execution is initiated on the initial computing system. For example, the data set corresponding to the service is being processed, by the initial computing system, using the online application to generate data processing results to be transmitted to the user device.

At 314, a status of the initial computing system is updated in the database to enable automated control of system maintenance state for the initial computing system by using the data stored in the database. For example, the execution of the service can be added to the activity status of the initial computing system stored in the database.

At 316, if the service execution is determined to be incompatible with an ongoing process, a scheduled process, and/or planned maintenance process, the service execution, can be blocked at the initial computing system. The blocked service can be redirected to a different computing system of the server system, for example, by a load balancer of the server system.

In some implementations, the current subject matter can be configured to be implemented in a system 400, as shown in FIG. 4. The system 400 can include a processor 410, a memory 420, a storage device 430, and an input/output device 440. Each of the components 410, 420, 430 and 440 can be interconnected using a system bus 450. The processor 410 can be configured to process instructions for execution within the system 400. In some implementations, the processor 410 can be a single-threaded processor. In alternate implementations, the processor 410 can be a multi-threaded processor. The processor 410 can be further configured to process instructions stored in the memory 420 or on the storage device 430, including receiving or sending information through the input/output device 440. The memory 420 can store information within the system 400. In some implementations, the memory 420 can be a computer-readable medium. In alternate implementations, the memory 420 can be a volatile memory unit. In yet some implementations, the memory 420 can be a non-volatile memory unit. The storage device 430 can be capable of providing mass storage for the system 400. In some implementations, the storage device 430 can be a computer-readable medium. In alternate implementations, the storage device 430 can be a floppy disk device, a hard disk device, an optical disk device, a tape device, non-volatile solid state memory, or any other type of storage device. The input/output device 440 can be configured to provide input/output operations for the system 400. In some implementations, the input/output device 440 can include a keyboard and/or pointing device. In alternate implementations, the input/output device 440 can include a display unit for displaying graphical user interfaces.

In some implementations, one or more application function libraries in the plurality of application function libraries can be stored in the one or more tables as binary large objects. Further, a structured query language can be used to query the storage location storing the application function library.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more user device computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include user devices and servers. A user device and server are generally, but not exclusively, remote from each other and typically interact through a communication network. The relationship of user device and server arises by virtue of computer programs running on the respective computers and having a user device-server relationship to each other.

Further non-limiting aspects or implementations are set forth in the following numbered examples:

Example 1: A computer-implemented method comprising: receiving, by one or more processors, a request to perform an execution of a service at a computing system, determining, by the one or more processors, an activity status of the computing system identified to execute the service, the activity status comprising an identification of a process scheduled to be executed by the computing system, generating, by the one or more processors, a compatibility report indicating a compatibility between the execution of the service at the computing system and the process, selectively initiating, by the one or more processors, the execution of the service at the computing system based on the compatibility between the execution of the service at the computing system and the process.

Example 2: The computer-implemented method of example 1, wherein the service is called by an internal maintenance process or by a customer-controlled process.

Example 3: The computer-implemented method of example 1 or 2, wherein the compatibility report indicates a conflict between the execution of the service at the computing system and the process.

Example 4: The computer-implemented method of any of examples 1 to 3, wherein selectively initiating, by the one or more processors, the execution of the service at the computing system comprises blocking the execution of the service at the computing system.

Example 5: The computer-implemented method of any of examples 1 to 4, further comprising: redirecting, by the one or more processors, the service to another system identified as being free of conflicts with the service.

Example 6: The computer-implemented method of any of examples 1 to 5, wherein the activity status comprises a duration and a resource allocation for the process scheduled to be executed by the computing system.

Example 7: The computer-implemented method of any of examples 1 to 6, further comprising: adding, by the one or more processors, the execution of the service to the activity status.

Example 8: A non-transitory computer-readable storage medium comprising programming code, which when executed by at least one data processor, causes operations comprising: receiving a request to perform an execution of a service at a computing system, determining an activity status of the computing system identified to execute the service, the activity status comprising an identification of a process scheduled to be executed by the computing system, generating a compatibility report indicating a compatibility between the execution of the service at the computing system and the process, and selectively initiating the execution of the service at the computing system based on the compatibility between the execution of the service at the computing system and the process.

Example 9: The non-transitory computer-readable storage medium of example 8, wherein the service is called by an internal maintenance process or by a customer-controlled process.

Example 10: The non-transitory computer-readable storage medium of example 8 or 9, wherein the compatibility report indicates a conflict between the execution of the service at the computing system and the process.

Example 11: The non-transitory computer-readable storage medium of any of examples 8 to 10, wherein selectively initiating the execution of the service at the computing system comprises blocking the execution of the service at the computing system.

Example 12: The non-transitory computer-readable storage medium of any of examples 8 to 11, further comprising: redirecting the service to another system identified as being free of conflicts with the service.

Example 13: The non-transitory computer-readable storage medium of any of examples 8 to 12, wherein the activity status comprises a duration and a resource allocation for the process scheduled to be executed by the computing system.

Example 14: The non-transitory computer-readable storage medium of any of examples 8 to 13, further comprising: adding the execution of the service to the activity status.

Example 15: A system comprising: at least one data processor, and at least one memory storing instructions, which when executed by the at least one data processor, cause operations comprising: receiving a request to perform an execution of a service at a computing system, determining an activity status of the computing system identified to execute the service, the activity status comprising an identification of a process scheduled to be executed by the computing system, generating a compatibility report indicating a compatibility between the execution of the service at the computing system and the process, and selectively initiating the execution of the service at the computing system based on the compatibility between the execution of the service at the computing system and the process.

Example 16: The system of example 15, wherein the service is called by an internal maintenance process or by a customer-controlled process.

Example 17: The system of example 15 or 16, wherein the compatibility report indicates a conflict between the execution of the service at the computing system and the process.

Example 18: The system of any of examples 15 to 17, wherein selectively initiating the execution of the service at the computing system comprises blocking the execution of the service at the computing system.

Example 19: The system of any of examples 15 to 18, further comprising: redirecting the service to another system identified as being free of conflicts with the service.

Example 20: The system of any of examples 15 to 19, wherein the activity status comprises a duration and a resource allocation for the process scheduled to be executed by the computing system.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims. combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed is:

1. A computer-implemented method comprising:
receiving, by one or more processors, a request to perform an execution of a service at a computing system;
determining, by the one or more processors, an activity status of the computing system identified to execute the service, the activity status comprising an identification of a process scheduled to be executed by the computing system;
generating, by the one or more processors, a compatibility report indicating a compatibility between the execution of the service at the computing system and the process; and
selectively initiating, by the one or more processors, the execution of the service at the computing system based on the compatibility between the execution of the service at the computing system and the process.

2. The computer-implemented method of claim 1, wherein the service is called by an internal maintenance process or by a customer-controlled process.

3. The computer-implemented method of claim 1, wherein the compatibility report indicates a conflict between the execution of the service at the computing system and the process.

4. The computer-implemented method of claim 3, wherein selectively initiating, by the one or more processors, the execution of the service at the computing system comprises blocking the execution of the service at the computing system.

5. The computer-implemented method of claim 3, further comprising:
redirecting, by the one or more processors, the service to another system identified as being free of conflicts with the service.

6. The computer-implemented method of claim 1, wherein the activity status comprises a duration and a resource allocation for the process scheduled to be executed by the computing system.

7. The computer-implemented method of claim 1, further comprising:
adding, by the one or more processors, the execution of the service to the activity status.

8. A non-transitory computer-readable storage medium comprising programming code, which when executed by at least one data processor, causes operations comprising:
receiving a request to perform an execution of a service at a computing system;
determining an activity status of the computing system identified to execute the service, the activity status comprising an identification of a process scheduled to be executed by the computing system;
generating a compatibility report indicating a compatibility between the execution of the service at the computing system and the process; and
selectively initiating the execution of the service at the computing system based on the compatibility between the execution of the service at the computing system and the process.

9. The non-transitory computer-readable storage medium of claim 8, wherein the service is called by an internal maintenance process or by a customer-controlled process.

10. The non-transitory computer-readable storage medium of claim 8, wherein the compatibility report indicates a conflict between the execution of the service at the computing system and the process.

11. The non-transitory computer-readable storage medium of claim 10, wherein selectively initiating the execution of the service at the computing system comprises blocking the execution of the service at the computing system.

12. The non-transitory computer-readable storage medium of claim 10, wherein the operations further comprise:
redirecting the service to another system identified as being free of conflicts with the service.

13. The non-transitory computer-readable storage medium of claim 8, wherein the activity status comprises a duration and a resource allocation for the process scheduled to be executed by the computing system.

14. The non-transitory computer-readable storage medium of claim 8, wherein the operations further comprise:
adding the execution of the service to the activity status.

15. A system comprising:
at least one data processor; and
at least one memory storing instructions, which when executed by the at least one data processor, cause operations comprising:
receiving a request to perform an execution of a service at a computing system;
determining an activity status of the computing system identified to execute the service, the activity status comprising an identification of a process scheduled to be executed by the computing system;
generating a compatibility report indicating a compatibility between the execution of the service at the computing system and the process; and
selectively initiating the execution of the service at the computing system based on the compatibility between the execution of the service at the computing system and the process.

16. The system of claim 15, wherein the service is called by an internal maintenance process or by a customer-controlled process.

17. The system of claim 15, wherein the compatibility report indicates a conflict between the execution of the service at the computing system and the process.

18. The system of claim 17, wherein selectively initiating the execution of the service at the computing system comprises blocking the execution of the service at the computing system.

19. The system of claim 17, wherein the operations further comprise:
redirecting the service to another system identified as being free of conflicts with the service.

20. The system of claim 15, wherein the activity status comprises a duration and a resource allocation for the process scheduled to be executed by the computing system.
